(19) United States
(12) Patent Application Publication
(10) Pub. No.: US 2013/0189041 A1
(43) Pub. Date: Jul. 25, 2013

(54) Power Tool

(71) Applicants: Satoshi Abe, Hitachinaka (JP); Takahiro Okubo, Hitachinaka (JP); Kazutaka Iwata, Hitachinaka (JP)

(72) Inventors: Satoshi Abe, Hitachinaka (JP); Takahiro Okubo, Hitachinaka (JP); Kazutaka Iwata, Hitachinaka (JP)

(73) Assignee: Hitachi Koki Co., Ltd., Toyko (JP)

(21) Appl. No.: 13/639,139

(22) PCT Filed: Sep. 13, 2011
(86) PCT No.: PCT/JP2011/071291

§ 371 Date: Oct. 3, 2012

(30) Foreign Application Priority Data
Sep. 30, 2010 (JP) 2010-223000
Aug. 23, 2011 (JP) 2011-181513

(51) Int. Cl. B23B 49/00; B23Q 17/22; B25F 5/00

(52) U.S. Cl. CPC B23B 49/00; B25F 5/00; B23Q 17/22
USPC 408/5; 173/20; 408/16

(57) ABSTRACT

A power tool includes: a motor driving an end bit; a housing accommodating the motor; a distance measuring sensor provided at the housing; and a controlling section connected to the distance measuring sensor. The controlling section is configured to exclude an abnormal value from measurement value measured by the distance measuring sensor.

### TECHNICAL FIELD

The invention relates to a power tool, and more specifically to a drill capable of measuring depth of a hole of a workpiece drilled by an end bit.

### BACKGROUND ART

Drilling devices are conventionally known, such as a hammer drill that drills a hole in a workpiece by rotating an end bit and applying a striking force to the end bit. A drilling device includes, for generating a striking force, a motor, a cylinder, a piston disposed in the cylinder, a motion converting mechanism that converts a rotational force of the motor into reciprocating motion of the piston, a striking piece driven by the piston, and an intermediate piece hit by the striking piece. An end bit is mounted on an end part of the drilling device. The striking piece hits the intermediate piece so that the striking force is transmitted to the end bit via the intermediate piece. The rotational force of the motor is transmitted to the end bit, so that the end bit rotates about its axial center.

In addition, the drilling device is provided with a gauge that extends in a longitudinal direction of the end bit. When a hole is drilled by the end bit to a desired depth in the workpiece, the longitudinal end of the gauge abuts a surface of workpiece, so that a user of the drilling device can recognize that the hole is drilled to the desired depth. Such a hammer drill is described in Japanese Patent Application Publication No. 2009-241229, for example. In the hammer drill shown in Japanese Patent Application Publication No. 2009-241229, the gauge sometimes gets in the way during drilling a hole. Hence, as a drilling device using a gauge, a drilling device is proposed that measures distance to a workpiece by a sensor.

### DISCLOSURE OF INVENTION

### Technical Problem

In measurement of distance by a sensor, an optical sensor such as an infrared sensor is used. In drilling work, however, dusts are blown up and the sensor is affected by the dusts, resulting that accurate measurement of distance sometimes cannot be performed.

Accordingly, it is an object of the invention to provide a drilling device capable of drilling a hole in an accurate drilling depth with a configuration in which a gauge is not provided.

### Solution to Problem

This and other objects of the present invention will be attained by a power tool including: a motor driving an end bit; a housing accommodating the motor; a distance measuring sensor provided at the housing; and a controlling section connected to the distance measuring sensor. The controlling section is configured to exclude an abnormal value from measurement value measured by the distance measuring sensor.

Further, in order to attain the above and other objects, the present invention provides a drilling device including: a mounting section to which a drill bit is mounted; a housing holding the mounting section; a distance measuring sensor provided at the housing; and a controlling section connected to the distance measuring sensor. The controlling section includes an abnormal value excluding section that compares the measurement result with an imaginary drilling depth, and that excludes the measurement result when the measurement result shows an abnormal value being out of a predetermined range defined by a threshold value determined from the imaginary drilling depth.

With these configurations, since the abnormal value of the measurement result is excluded, accurate measurement of distance can be performed.

It is preferable that the controlling section further includes an average drilling speed calculating section that calculates an average drilling speed, subsequent to a first time in which a first period has elapsed after a start of drilling, based on the measurement result during the first period before the first time; and an imaginary drilling depth predicting section that predicts the imaginary drilling depth during a second period after the first time, based on the average drilling speed.

It is preferable that the controlling section further includes a storage section that stores the measurement result of the distance measuring sensor.

It is preferable that the average drilling speed calculating section is configured to change the first period, and the imaginary drilling depth predicting section is configured to change the second period.

It is preferable that the abnormal value excluding section is configured to change the predetermined range defined by the threshold value.

With these configurations, since the first period, the second period, and the threshold value can be set according to the drilling depth and a property of an object to be drilled, the average drilling speed can be calculated with more precision.

It is preferable that the drilling device further including a motor driving the drilling bit; and a transmitting mechanism that is provided between the drilling bit and the motor and transmits output of the motor to the drilling bit. The transmitting mechanism transmits the output of the motor to the drilling bit as a rotational force or as a rotational force and a striking force.

It is preferable that the drilling device further includes an abnormal-value exclusion control section that controls an operation and a non-operation of the abnormal value excluding section.

With this configuration, if too much dusts are not generated, an unnecessary operation can be avoided.

It is preferable that the drilling device further includes a motor that rotates by electric power and that drives the drilling bit. The controlling section further includes an electric current detecting section, a rotational speed detecting section, and a power cutoff section. The electric current detecting section detects an electric current supplied to the motor. The rotational speed detecting section detects a rotational speed of the motor. The power cutoff section cuts off power supply to the motor when at least one of two condition is satisfied and when the abnormal value excluding section detects the abnormal value of the measurement result. One condition is such that the electric current detecting section detects an abnormal value of the electric current. The other condition is such that the rotational speed detecting section detects an abnormal value of the rotational speed.

With this configuration, by detecting the rotational speed of the motor and the electrical current, the drilling operation can be stopped when the drilling bit penetrates the object to be drilled.

### BRIEF DESCRIPTION OF DRAWINGS

FIG. 1 is a cross-sectional view of a drilling device according to an embodiment of the present invention;

FIG. 2 is a cross-sectional view of a distance sensor of the embodiment of the present invention;

FIG. 3 shows an input section of the drilling device according to the embodiment of the present invention;

FIG. 4 is a circuit diagram showing a control circuit section, an inverter circuit section and a motor according to the embodiment of the present invention;

FIG. 5 is a graph showing a relationship between an output voltage and a measurement distance of the distance sensor according to the embodiment of the present invention;

FIG. 6 is a explanatory diagram showing a shape of a hole formed on a workpiece by an end bit according to the embodiment of the present invention;

FIG. 7 is a flowchart illustrating steps in an effective depth deriving program according to the embodiment of the present invention;

FIG. 8 is a flowchart illustrating steps in a rotation stopping program according to the embodiment of the present invention;

FIG. 9 is a flowchart illustrating steps in a rotation stopping program according to a modification to the rotation stopping program shown in FIG. 9;

FIG. 10 is a graph showing a relationship between an imaginary line and a measurement value according to the embodiment of the present invention;

FIG. 11 is a flowchart illustrating steps in a change rate predicting process program according to the embodiment of the present invention;

FIG. 12 is a cross-sectional view of the drilling device with a first calibration jig according to the embodiment of the present invention;

FIG. 13 is a cross-sectional view of the drilling device with a second calibration jig according to the embodiment of the present invention;

FIG. 14 is a flowchart illustrating steps in a calibration program according to the embodiment of the present invention;

FIG. 15 is a flowchart illustrating steps in a calibration program according to a modification to the calibration program shown in FIG. 14;

FIG. 16 is a flowchart illustrating steps in a change rate predicting process program according to a modification to the change rate predicting process program shown in FIG. 11.

### MODE FOR CARRYING OUT THE INVENTION

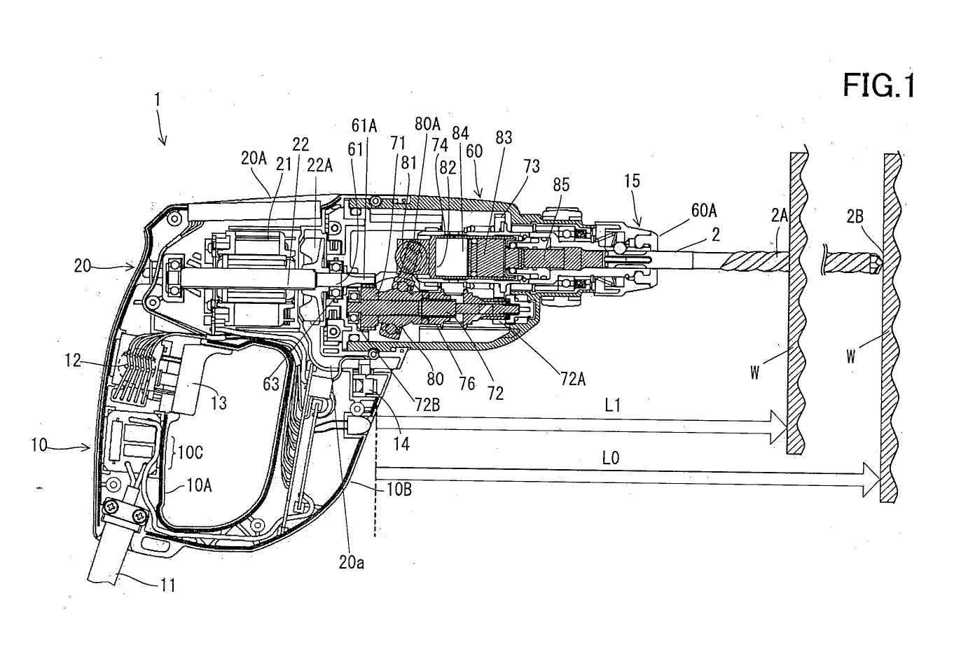

An embodiment of a drilling device according to the invention will be described while referring to FIGS. 1 through 15. As shown in FIG. 1, a drilling device 1 is a rotary hammer drill for drilling a hole into a workpiece W. A housing of the drilling device 1 is formed by a handle section 10, a motor housing 20, and a gear housing 60. Hereinafter, the front-to-rear direction is defined so that the right side in FIG. 1 (the tip end side of an end bit 2) is the front side of the drilling device 1. Further, the upper-to-lower direction is defined so that the direction perpendicular to the front-to-rear direction. A side in which the handle section 10 extends from the motor housing 20 is the lower side in the upper-to-lower direction. The workpiece W is located at the front side of the drilling device 1. The length of the housing in the front-to-rear direction, that is, the length in the left-to-right direction in FIG. 1 is approximately 30 cm (centimeters) to 40 cm.

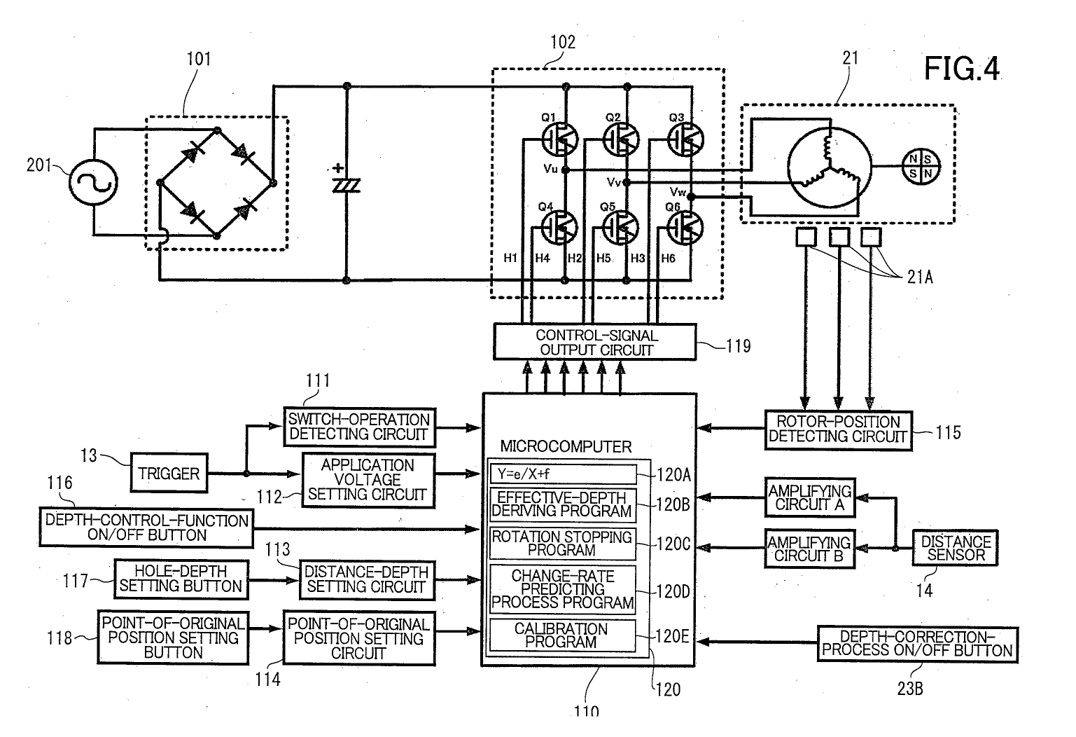

The handle section 10 is integrally molded with plastic and has substantially a U-shape. A motor accommodating section 20A is defined above the handle section 10. The motor accommodating section 20A constitutes part of the motor housing 20 and accommodates a motor 21 described later. A power cable 11 is attached to a lower section of a rear section 10A of the handle section 10. Also, a switch mechanism 12 connected to the motor 21 described later is built in the rear section 10A of the handle section 10. The switch mechanism 12 is mechanically connected to a trigger 13 that can be operated by an operator. By operating the trigger 13, supply or stopping of power to an inverter circuit section 102 (FIG. 4) is switched. Further, a part of the rear section 10A of the handle section 10 immediately below the trigger 13 constitutes a grip section 10C that is gripped by the middle finger and the third finger when an operator of the drilling device 1 grips the rear section 10A.

A distance sensor 14 directed to the front side is provided on an upper section of a front section 10B of the handle section 10. The distance sensor 14 is an infrared sensor with wavelength of approximately 850 nm (nanometers). The distance sensor 14 is capable of measuring a distance X (as measurement value) from the distance sensor 14 to the workpiece W in the front-to-rear direction.

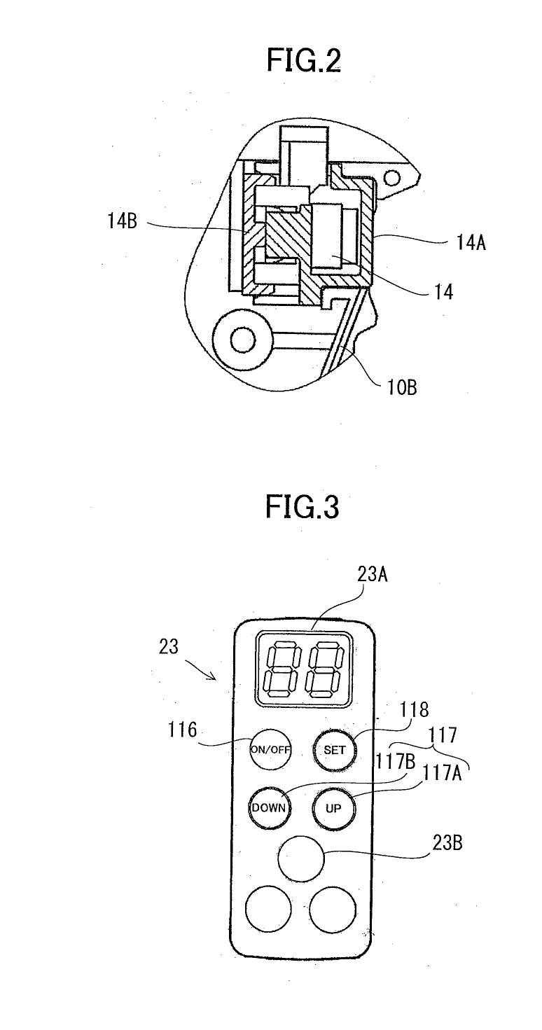

As shown in FIG. 2, the distance sensor 14 is substantially entirely covered by a cover 14A made of resin. A rear section of the cover 14A is fixed to an upper section of the front section 10B of the handle section 10 via an elastic member 14b made of rubber. The distance sensor 14 is electrically connected to a microcomputer 110 (FIG. 4) described later. The distance sensor 14 is also electrically connected to a hole depth setting button 117 (FIG. 4) of an input section 23 described later. As will be described later, a desired drilling depth can be inputted at the hole depth setting button 117. More specifically, a value of inputted drilling depth is approximately 3 cm to 6 cm.

The input section 23 serving as an input terminal (an input section) is provided on an outer surface and at an upper position of the motor housing 20. The motor 21 is accommodated inside the input section 23. As shown in FIG. 3, the input section 23 includes a display section 23A displayed digitally, a depth-control-function ON/OFF button 116, the hole depth setting button 117, a point-of-original position setting button 118, and a depth-correction-process ON/OFF button 23B. The depth-control-function ON/OFF button 116 is for performing switching whether to drill a hole at depth set by the hole depth setting button 117 described later (depth control function ON) or to drill a hole regardless of the set depth (depth control function OFF). The depth-control-function ON/OFF button 116 also functions, by pressing and holding the button, as a calibration mode switching button by which the microcomputer 110 described later goes to a calibration mode.

The hole depth setting button 117 is for performing setting of a hole depth to be drilled, and has an UP button 117A and a DOWN button 117B. The point-of-original position setting button 118 is for performing setting of a position of point of origin by pressing the button when the drilling device 1 is set at the position of point of origin with respect to the hole to be drilled. By pressing and holding (longer than five seconds) the point-of-original position setting button 118, ON and OFF of the calibration mode described later is switched. The depth-correction-process ON/OFF button 23B is for performing setting whether to use a correction value (Ls) described later. Each of these buttons is connected to the microcomputer 110 described later.

The motor 21 shown in FIG. 1 is a three-phase direct-current brushless motor. Rotation of the motor 21 is controlled by the microcomputer 110 described later. The motor 21 includes an output shaft 22 extending toward the front side and having an axial direction in the front-to-rear direction. The output shaft 22 outputs a rotational driving force. An axial fan 22A is provided at a base section of the output shaft 22 so as to be rotatable coaxially and together with the output shaft 22. As shown in FIG. 1, an air passage 20a is provided at a position below the axial fan 22A. The air passage 20a extends downward from the axial fan 22A, and is communicated with spaces confronting an upper portion, a front end portion, and a rear end portion of the distance sensor 14. Upon rotation of the axial fan 22A, air is introduced to a position adjacent to the motor 21 through an air inlet formed in a rear portion of the motor housing 20, and the air passes through the air passage 20a and along the upper and rear portions of the distance sensor 14 to cool the distance sensor 14. Further, the air also passes along the front portion of the distance sensor 14. This air can prevent the drilling chips formed by the rotation of the end bit 2 from being deposited onto the surface of the distance sensor 14.

The gear housing 60 is formed by resin molding, and is provided at the front side of the motor housing 20. Within the gear housing 60, a first intermediate shaft 61 is provided to extend from the output shaft 22 and to be coaxial with the output shaft 22.

The first intermediate shaft 61 is rotatably supported by a bearing 63. The rear end of the first intermediate shaft 61 is coupled to the output shaft 22. A fourth gear 61A is provided at the front end of the first intermediate shaft 61. Within the gear housing 60, a second intermediate shaft 72 is supported, in parallel with the output shaft 22, by a bearing 72B so as to be rotatable about its axial center.

A fifth gear 71 meshingly engaged with the fourth gear 61A is coaxially fixed to the rear end of the second intermediate shaft 72. A gear section 72A is formed at the front side of the second intermediate shaft 72. The gear section 72A is meshingly engaged with a sixth gear 73 described later. A cylinder 74 is provided at a position within the gear housing 60 and above the second intermediate shaft 72. The cylinder 74 extends in parallel with the second intermediate shaft 72 and is supported rotatably. The sixth gear 73 is fixed to the outer circumference of the cylinder 74. The cylinder 74 is rotatable about its axial center by meshing engagement with the above-described gear section 72A.

An end bit holding section 15 is provided at the front side of the cylinder 74. The end bit 2 described later can be detachably mounted on the end bit holding section 15. An intermediate part of the second intermediate shaft 72 is in spline engagement with a clutch 76 that is urged rearward by a spring. The clutch 76 can be switched between a hammer drill mode and a drill mode by a change lever (not shown) provided at the gear housing 60. At the motor 21 side of the clutch 76, a motion converting mechanism 80 for converting rotational motion into reciprocating motion is rotatably provided at the outside of the second intermediate shaft 72. An arm section 80A of the motion converting mechanism 80 is movable reciprocally in the front-to-rear direction of the drilling device 1 by rotation of the second intermediate shaft 72.

A piston 82 is provided within the cylinder 74. The piston 82 is mounted so as to be capable of reciprocating in the direction parallel to the axial direction of the second intermediate shaft 72 and to be movable slidably within the cylinder 74. A striking piece 83 is provided within the piston 82. An air chamber 84 is defined between the piston 82 and the striking piece 83 within the cylinder 74. An intermediate piece 85 is provided within the cylinder 74 at the opposite side from the air chamber 84 with respect to the striking piece 83 so as to be slidable in the moving direction of the piston 82. The end bit 2 serving as the end bit is located at a position at the opposite side from the striking piece 83 with respect to the intermediate piece 85. Thus, the striking piece 83 can hit the end bit 2 via the intermediate piece 85.

When the clutch 76 is switched to the hammer drill mode, the second intermediate shaft 72 and the motion converting mechanism 80 are coupled by the clutch 76. The motion converting mechanism 80 is connected so as to interlock, via a piston pin 81, with the piston 82 provided within the cylinder 74.

As shown in FIG. 1, the end bit 2 is a drill bit and includes a body section 2A having a round bar shape and formed with helical grooves and a tip end section 2B located at the tip end of the body section 2A and having a tapered shape, thereby drilling a hole into the workpiece W with the tip end section 2B at the forefront. Thus, the deepest part of a drilled hole has substantially a concave conical shape having a conical shape obtained by rotating the tapered tip end section 2B as the positive die. The end bit 2 is detachable from the end bit holding section 15 and is exchangeable.

Next, a control circuit section including the microcomputer 110 serving as the calculating section (controlling section) and circuit configuration of the inverter circuit section 102 and the motor 21 will be described with reference to FIG. 4. The control circuit section includes a switch operation detecting circuit 111, an application voltage setting circuit 112, a distance depth setting circuit 113, a point-of-original position setting circuit 114, a rotor position detecting circuit 115, a control signal output circuit 119, an amplifying circuit A, and an amplifying circuit B.

The switch operation detecting circuit 111 detects whether the trigger 13 has been pressed, and outputs the detection result to the microcomputer 110. The application voltage setting circuit 112 sets, according to a target value signal outputted from the trigger 13, PWM duty of PWM driving signal for driving switching elements Q1 through Q6 of the inverter circuit section 102, and outputs the set PWM duty to the microcomputer 110.

The distance depth setting circuit 113 is connected to the hole depth setting button 117. When the end bit 2 drills a hole to a value inputted by the hole depth setting button 117 in a state of depth control function ON, the distance depth setting circuit 113 outputs, to the microcomputer 110, a signal for stopping power supply to the motor 21. The point-of-original position setting circuit 114 is connected to the point-of-original position setting button 118. When the point-of-original position setting button 118 is pressed, the point-of-original position setting circuit 114 outputs, to the microcomputer 110, a signal for setting a point of original for a hole to be drilled by the end bit 2. The rotor position detecting circuit 115 detects a rotational position of a rotor of the motor 21 based on rotational position detection signals outputted from Hall ICs 21A, and outputs the detected rotational position to the microcomputer 110. The amplifying circuit A and the amplifying circuit B are connected to the distance sensor 14.

The microcomputer 110 calculates a target value of PWM duty based on outputs from the application voltage setting circuit 112. The microcomputer 110 also determines a stator winding to be appropriately energized based on outputs from the rotor position detecting circuit 115, and generates output switching signals H1 through H3 and PWM driving signals H4 through H6. Duty widths of the PWM driving signals H4 through H6 are determined based on the target value of PWM duty, and then the PWM driving signals H4 through H6 are outputted. The control signal output circuit 119 outputs the output switching signals H1 through H3 and the PWM driving signals H4 through H6 to the inverter circuit section 102.

Alternate current (AC) power from a commercial power source is supplied to the inverter circuit section 102 via a rectifier circuit 101. In the inverter circuit section 102, switching elements are driven based on the output switching signals H1 through H3 and the PWM driving signals H4 through H6, and the stator winding to be energized is determined. Further, the PWM driving signal is switched by the target value of PWM duty. Thus, three-phase AC voltages with electric angle of 120 degrees are applied sequentially to three-phase stator windings (U, V, W) of the motor 21. Further, in the inverter circuit section 102, the switching elements can be driven so as to stop rotation of the output shaft 22 based on signals from the microcomputer 110 via the control signal output circuit 119.

The amplifying circuit A can amplify voltage outputted from the distance sensor 14 by a first gain (first amplification factor). The amplifying circuit B can amplify voltage outputted from the distance sensor 14 by a second gain (second amplification factor) larger than the first gain. In the amplifying circuit A and the amplifying circuit B, voltages are constantly amplified and outputted when the drilling device 1 is operating.

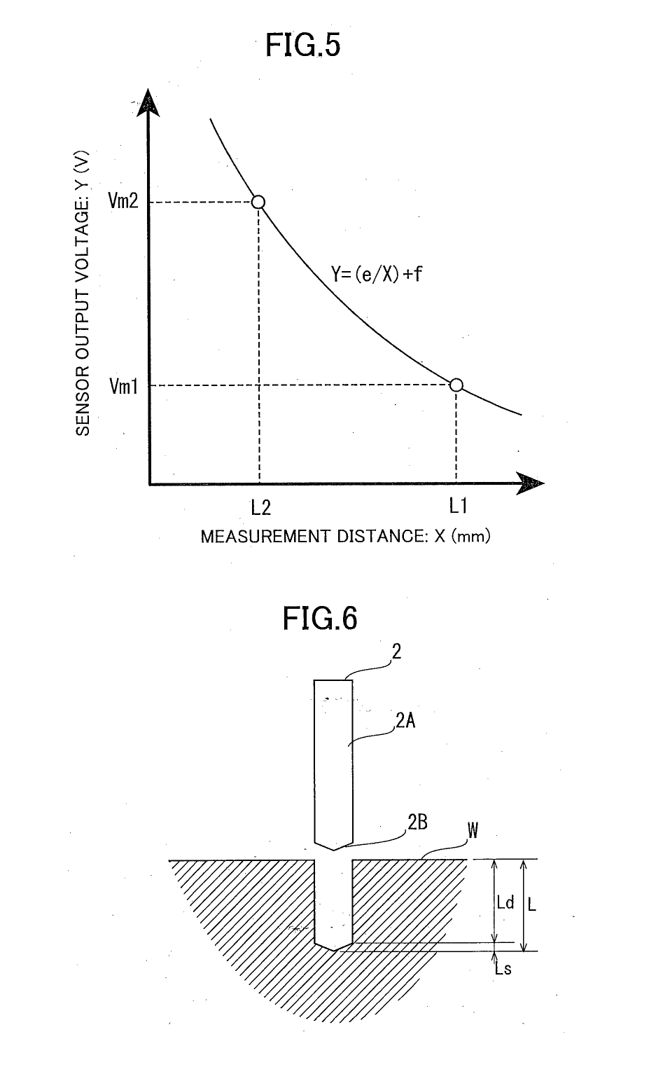

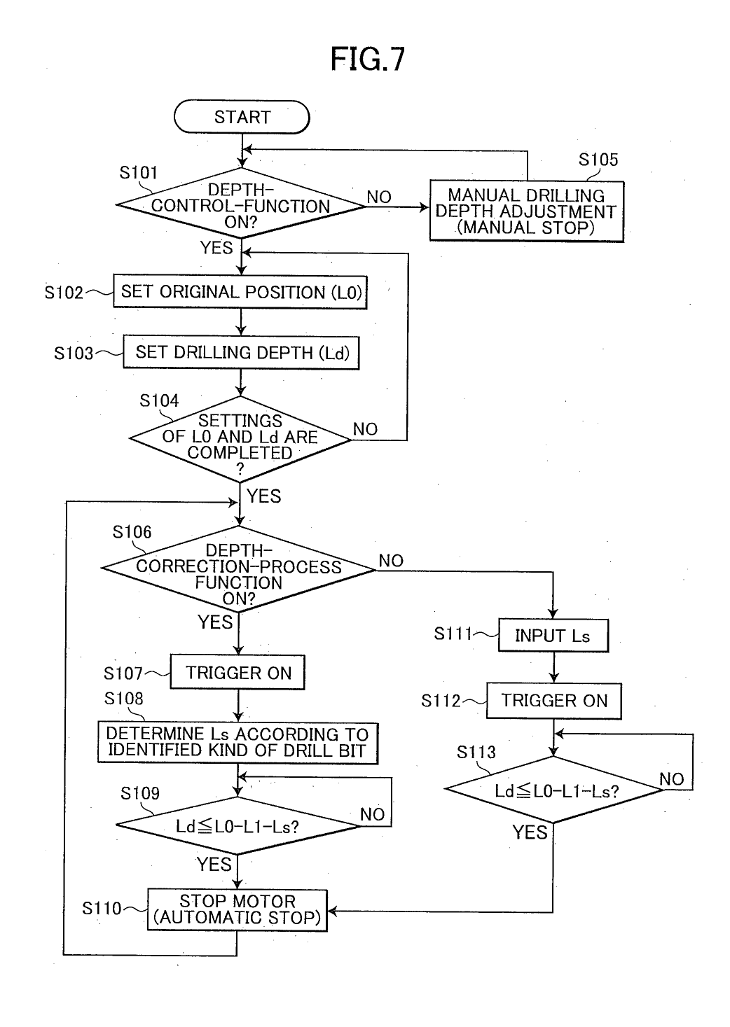

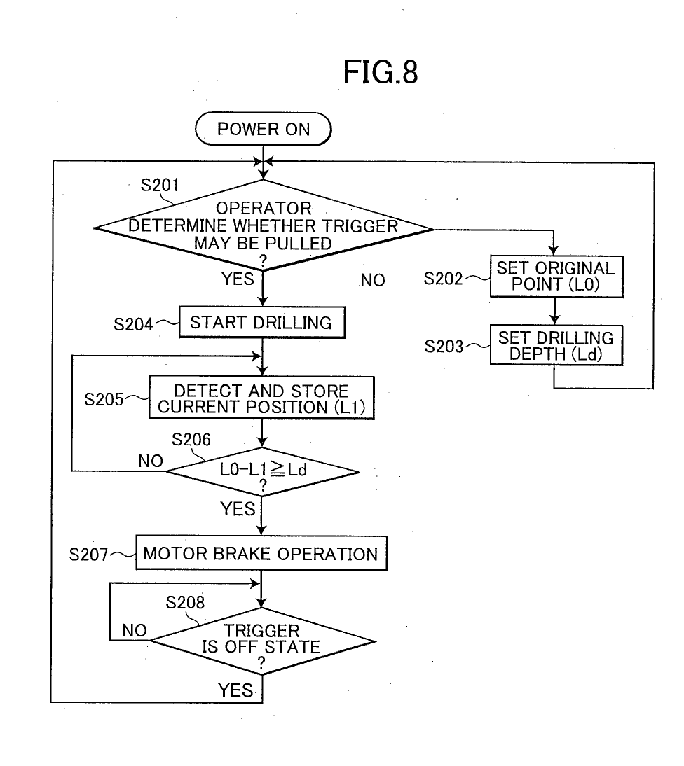

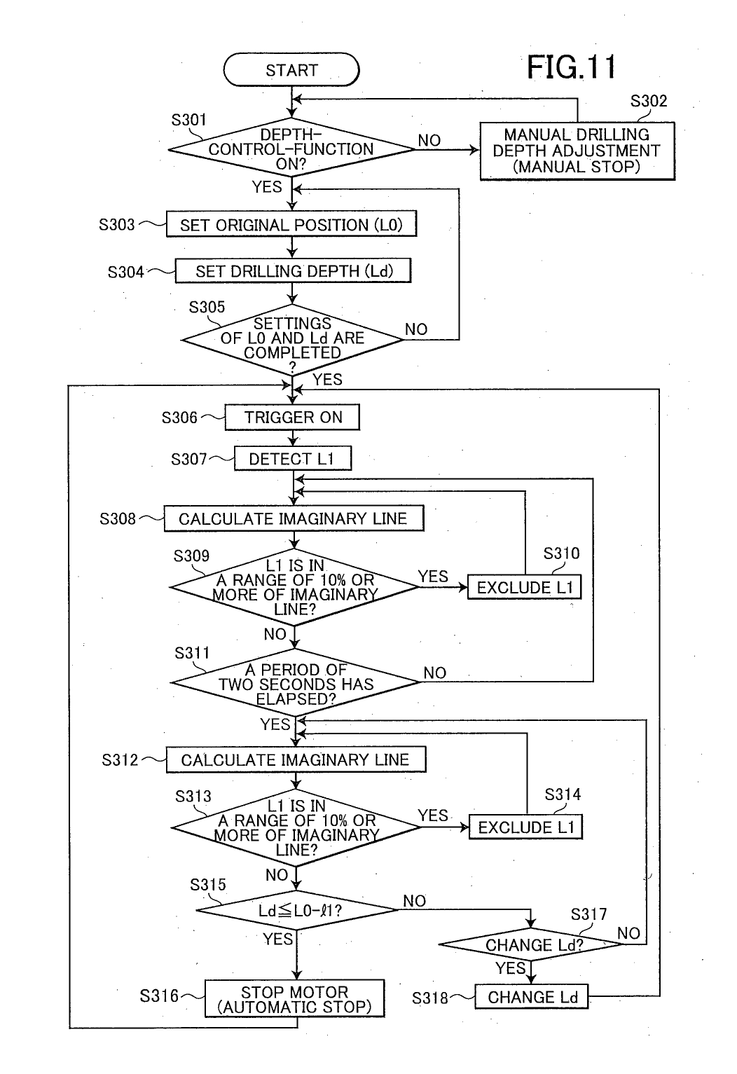

The microcomputer 110 includes a storage device 120 such as a ROM and the like, serving as a storage section. The storage device 120 stores therein a mathematical expression program 120A that is a mathematical expression A (Y=e/X+f) based on the graph of FIG. 5, an effective depth deriving program 120B that is an effective depth deriving section having a map (not shown) described later and described with reference to the flowchart of FIG. 7, a rotation stopping program 120C described with reference to the flowchart of FIG. 8, a change rate predicting process program 120D described with reference to the flowchart of FIG. 11, and a calibration program 120E serving as a calibration section and described with reference to the flowchart of FIG. 11. In the mathematical expression program 120A, Y is output results of the amplifying circuit A and the amplifying circuit B; X is measurement distance (the above-described distance from the distance sensor 14 to the workpiece W in the front-to-rear direction); and e and f are coefficients obtained by calibration. Thus, in the microcomputer 110, the measurement distance X is calculated from the output results of the amplifying circuit A and the amplifying circuit B (sensor output voltage: Y), and the measurement result is displayed on the display section 23A. The map (not shown) included in the effective depth deriving program 120B stores: a standard length depending on each diameter of the end bit 2; and a correction value depending on the length (depth of the deepest part of the concave conical shape described later=length of the tip end section 2B (Ls)). The storage device 120 functions as a storage section for storing various values in each of the flowcharts described later.

When the motor 21 of the above-described drilling device 1 is driven, a rotational output is transmitted to the second intermediate shaft 72 via the first intermediate shaft 61, the fourth gear 61A, and the fifth gear 71. Rotation of the second intermediate shaft 72 is transmitted to the cylinder 74 by meshingly engagement between the gear section 72A and the sixth gear 73, and rotational force is transmitted to the end bit 2. When the clutch 76 is moved to the hammer drill mode, the clutch 76 couples with the motion converting mechanism 80, and rotational driving force of the second intermediate shaft 72 is transmitted to the motion converting mechanism 80. In the motion converting mechanism 80, rotational driving force is converted into reciprocating motion of the piston 82 via the piston pin 81. The reciprocating motion of the piston 82 causes pressure of air in the air chamber 84 defined between the striking piece 83 and the piston 82 to repeat increasing and decreasing, so that a striking force is applied to the striking piece 83. The striking piece 83 moves forward and hits the rear end surface of the intermediate piece 85, and a striking force is transmitted to the end bit 2 via the intermediate piece 85. In this way, in the hammer drill mode, both of the rotational force and striking force are applied to the end bit 2 simultaneously.

When the clutch 76 is in the drill mode, the clutch 76 cuts off connection between the second intermediate shaft 72 and the motion converting mechanism 80, and only rotational driving force of the second intermediate shaft 72 is transmitted to the cylinder 74 via the gear section 72A and the sixth gear 73. Hence, only the rotational force is applied to the end bit 2.

In the above-described hammer drill mode or drill mode, the drilling device 1 is held so that the center axis of the end bit 2 (the axis in parallel with the front-to-rear direction of the end bit 2) is perpendicular to the plane of the workpiece W, and also the depth-control-function ON/OFF button 116 is pressed to set the microcomputer 110 to the state of depth control function ON. In this state, the UP button 117A and the DOWN button 117B are operated to set a desired drilling depth, the point-of-original position setting button 118 is operated to set the point-of-original position, and subsequently the trigger 13 is pulled to drill a hole. During drilling, the drilling depth is constantly detected by the distance sensor 14. When the drilling depth reaches a set value (the desired drilling depth), the microcomputer 110 automatically stops power supply to the motor 21.

The measurement distance X that is a value detected by the above-described distance sensor 14 is calculated by the mathematical expression A corresponding to the above-described graph of FIG. 5. This value is calculated based on how far the distance sensor 14 has approached the workpiece W starting from the point-of-original position. The point-of-original position (X=L0) is a value detected by the distance sensor 14 when the tip end of the tip end section 2B is in contact with the workpiece W in a state where the center axis of the end bit 2 is perpendicular to the plane of the workpiece W. Based on the measurement value (X=L1) detected by the distance sensor 14 and the point-of-original position (X=L0), the drilling depth (actual depth: L) of the end bit 2 is calculated by an expression of L=L0−L1. As shown in FIG. 6, the actual depth L corresponds to distance from the opening to the deepest part of the concave conical shape (L=Ld+Ls in FIG. 6) in a hole in the workpiece W drilled by the end bit 2.

When an anchor bolt having substantially the same diameter and length as the inner diameter and the actual depth L of the hole, for example, is buried, a leading end part of the anchor bolt cannot be inserted to the position of the concave conical shape. Hence, there is possibility that a trailing end part of the anchor bolt protrudes from the opening of the hole by approximately distance Ls. Accordingly, when a hole is drilled with a setting value Ld with the depth control function ON, it is necessary to consider drilling depth (effective depth: L−Ls=L0−L1−Ls) obtained by excluding the depth (Ls) of the part forming the concave conical shape formed by the tip end section 2B of the end bit 2, not the actual depth L that is the drilling depth of a hole formed actually. In other words, the setting value Ld needs to be equal to the length of the anchor bolt.

Next, a drill procedure for the drilling device 1 will be described while referring to FIG. 7. As shown in the flowchart of FIG. 7, first in S101, the microcomputer 110 determines whether the depth-control-function ON/OFF button 116 has been pressed. If it is determined that the depth-control-function ON/OFF button 116 has been pressed in S101 (S101: YES), in S102 the operator sets an initial position (L0; point-of-original position), and then in S103 the operator sets a setting value (Ld) of the drilling depth by using the UP button 117A and the DOWN button 117B. If it is determined that the depth-control-function ON/OFF button 116 has not been pressed in S101 (S101: NO), in S105 the drill operation is performed according to manual drilling depth adjustments based on an operation of the trigger 13, without using the depth control function. After S105, the microcomputer 110 loops back to S101.

In S104, if settings of the initial position (L0) and the setting value (Ld) are not completed (S104: NO), the microcomputer 110 loops back to S102. In S104, if setting of the initial position (L0) and the setting value (Ld) is completed (S104: YES), in S106 the microcomputer 110 determines whether the depth-correction-process ON/OFF button 23B has been pressed. In S106, if the depth-correction-process ON/OFF button 23B has been pressed (S 106: YES), the microcomputer 110 proceeds to S107. If the depth-correction-process ON/OFF button 23B has not been pressed (S106: NO), the microcomputer 110 proceeds to S111.

If it is determined as YES in S106, the microcomputer 110 calls a map (not shown) from the effective depth deriving program 120B stored in the storage device 120, and proceeds to S107 and supplies the motor 21 with power by being pressed the trigger 13 to rotate the end bit 2. The microcomputer 110 then proceeds to S108 and identifies the kind of the mounted end bit 2 from the current position (X=L1=L0) which is the measurement value at the beginning of drilling, that is, the point-of-original position (L0).

The microcomputer 110 calculates the drilling depth: L0−L1−Ls using the above-described correction value (Ls) according to the identified kind. Next, the microcomputer 110 proceeds to S109 to detect whether the drilling depth has reached the setting value (whether L0−L1−Ls≧Ld is satisfied). In S109, only if the predetermined depth has been reached (S109: YES), the microcomputer 110 proceeds to S110 to stop power supply to the motor 21, and loops back to S106 to prepare for the next operation.

If it is determined as NO in S106, the microcomputer 110 proceeds to S111 where the correction value (Ls) is manually inputted with the UP button 117A and the DOWN button 117B. Subsequently, the microcomputer 110 proceeds to S112 where the trigger 13 is operated to supply the motor 21 with power and to rotate the end bit 2. The microcomputer 110 then proceeds to S113 to detect whether the drilling depth has reached the setting value (whether L0−L1−Ls≧Ld is satisfied). In S113, only if the predetermined depth has been reached (S113: YES), the microcomputer 110 proceeds to S110 to stop power supply to the motor 21, and loops back to S106 to prepare for the next operation.

By deriving the drilling depth (effective depth) in this way, the drilling depth (the actual depth) that is drilled actually becomes deeper than depth necessary for inserting an object, for example, an anchor bolt etc. to be inserted in the drilled hole. In other words, the drilling depth becomes longer than the length of anchor bolt etc. Thus, depth that is actually drilled (actual depth: L) becomes deeper than drilling depth desired by an operator (setting value: Ld), thereby suppressing the anchor bolt etc. from protruding from the drilling hole when the anchor bolt etc. is inserted.

In S108, the kind of the end bit 2 is identified, the above-described correction value (Ls) is identified from the table or map (not shown) in accordance with the identified kind. According to this configuration, the correction value can be derived with ease, and the effective drilling depth can be derived more simply.

In the above-described flowchart, S106 through S113 serve as an effective depth deriving section and effective depth deriving step, and S108 serves as a correction value deriving section and correction value deriving step.

With the above-described effective depth deriving program 120B (the flowchart of FIG. 7), at least a hole in which an anchor bolt etc. can be inserted reliably can be drilled with the correction value (Ls) taken into consideration. However, at the end of drilling, if power supply to the motor 21 is merely stopped, there is possibility that, after power supply to the motor 21 is stopped, the end bit 2 further may rotate and drill to a deeper position due to inertia without any countermeasure. Thus, in order to prevent this, brake is applied to the motor 21 at the end of drilling to reliably stop rotation of the end bit 2.

Next, another drill procedure for the drilling device 1 will be described while referring to FIG. 8. As shown in the flowchart of FIG. 8, in S201, the operator determines whether the trigger 13 may be pulled after a power is applied to the drilling device 1. In S201, if the point-of-original position (L0) and the setting value (Ld) which is the drilling depth are already inputted (S201: YES), the operator pulls the trigger 13. If the point-of-original position (L0) and the setting value (Ld) are not inputted (S201: NO), the operator does not pull the trigger 13 and sets the point-of-original position (L0) and the setting value (Ld) in S202.

In S204, power is supplied to the motor 21 to start drilling in response to a pulling operation of the trigger 13. Next, in S205, the microcomputer 110 detects the current position (L1) which is the current measurement value with the distance sensor 14, and stores the detected value. The microcomputer 110 further proceeds to S206 to determine whether the drilling depth has reached the setting value (L0−L1≧Ld). If the drilling depth has not reached the setting value (S206: NO), the microcomputer 110 returns to S205 to detects the current position (L1). On the other hand, if the drilling depth has reached the setting value (S206: YES), the microcomputer 110 proceeds to S207 and outputs a signal to the inverter circuit section 102 in order to apply brake to the motor 21, thereby forcibly stop rotation of the motor 21 (braking section). Then, if the microcomputer 110 determines that the trigger 13 has been returned from a pulled state (S208: YES), the microcomputer 110 loops back to S201 and ends the process. On the other hand, if the microcomputer 110 determines that the trigger 13 has not been returned from a pulled state (S208: NO), the microcomputer 110 repeats this determination.

By forcibly stopping rotation of the motor 21 at the same time the drilling depth reaches the setting value Ld, rotation of the end bit 2 can be stopped after the drilling depth reaches the setting value. Thus, no further drilling operation is performed after the drilling depth reaches the setting value, and drilling can be performed at an accurate drilling depth.

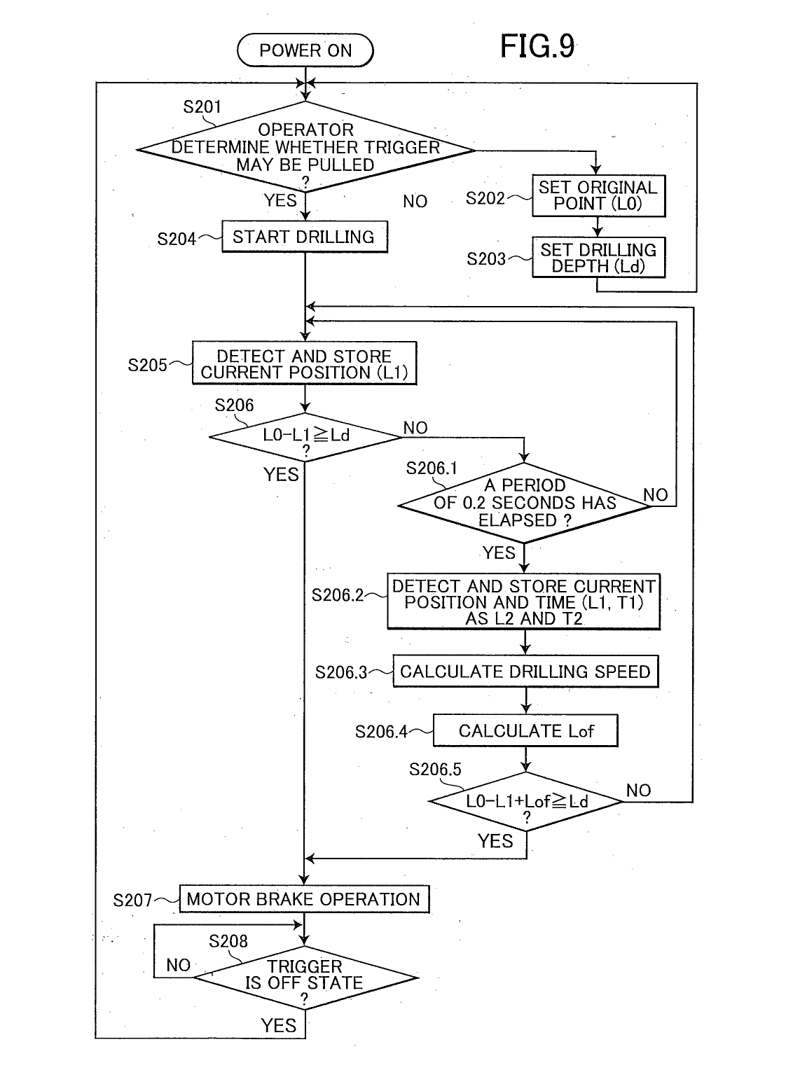

In the flowchart shown in FIG. 8, rotation of the end bit 2 (rotation of the motor 21) is forcibly stopped based on the timing at which the drilling depth reaches the setting value (Ld), but it is not limited to this timing. The timing of stopping may be predicted, and the motor 21 may be stopped before the drilling depth reaches the setting value (Ld). Specifically, as shown in the flowchart of FIG. 9, steps S206.1 through S206.5 are added between S206 and S207. Steps S206.1 through S206.5 will be described below. The steps other than S206.1 through S206.5 are identical to those in the flowchart of FIG. 8, and descriptions will be omitted.

First, if the drilling depth has not reached the setting distance (setting value) in S206 (S206: NO), the microcomputer 110 proceeds to S206.1 and determines whether a period of 0.2 seconds has elapsed after the previous storage timing (storage timing at S205). If it is determined that a period of 0.2 seconds has not elapsed (S206.1: NO), the microcomputer 110 loops back to S205. If it is determined that a period of 0.2 seconds has elapsed (S206.1: YES), the microcomputer 110 proceeds to S206.1, detects a current position (L1) and a current time (T1) corresponding to the detected current position (L1), and stores the detected current position (L1) as a position (L2) and the detected current time (T1) as a time (T2). The microcomputer 110 then proceeds to S206.3, detects a current position (L1) and a current time (T1), and calculates a drilling speed from the detected current position (L1) and the detected current time (T1) as well as the stored position (L2) and time (T2). Here, the drilling speed is a speed at which the end bit 2 drills into the workpiece W.

In S206.4, the microcomputer 110 calculates, based on the calculated drilling speed, an offset amount L of which is a distance by which the end bit 2 is assumed to drill (advance) even after the motor 21 is stopped. This calculation can be derived from a relational expression (not shown) or a table (not shown) between the drilling speed and the offset amount (L of) that is obtained from experiments or the like.

After the offset amount (L of) is calculated, the microcomputer 110 proceeds to S206.5, detects a current position (L1), and determines whether the drilling depth (L0-L1) has reached a value (Ld-Lof) obtained by subtracting the offset amount (L of) from the setting value (Ld) (that is, whether L0−L1+Lof≧Ld is satisfied). If it is determined that the drilling depth (L0−L1) has not reached the value (Ld−Lof) (S206.5: NO), the microcomputer 110 loops back to S205. If it is determined that the drilling depth (L0−L1) has reached the value (Ld−Lof) (S206.5: YES), the microcomputer 110 proceeds to S207.

Stopping the motor 21 based on prediction in this way can reliably prevent the drilling depth from becoming larger than the setting value Ld. The control shown in the flowchart of FIG. 9 is especially effective when drilling is performed into the workpiece W such as a thin plate where it is highly possible that the end bit 2 penetrate the workpiece by mistake. In the control shown in the flowchart of FIG. 9, a braking section (S207) identical to that in the flowchart of FIG. 8 is used. However, if operations of the end bit 2 subsequent to S207 can be predicted, S207 may be a step of merely cutting off power supply to the motor 21 (power cutoff section).

Further, in the both controls based on the flowcharts of FIGS. 8 and 9, rotation of the end bit 2 is stopped by the control of the motor 21, that is, only by electrical control. Hence, there is no increase in the number of components of the drilling device 1.

In order to calculate the above-mentioned drilling depth, as described above, the distance sensor 14 which is an infrared sensor is used, and calculation is performed by using actual measurement value that is measured by the distance sensor 14 as the measurement value (current position) (L1). Specifically, distances are measured in accordance with reflections of infrared rays irradiated from the distance sensor 14. However, if dusts are generated as a drilling operation progresses, there is possibility that the dusts reflect infrared rays irregularly, causing that accurate measurement of distance cannot be performed.

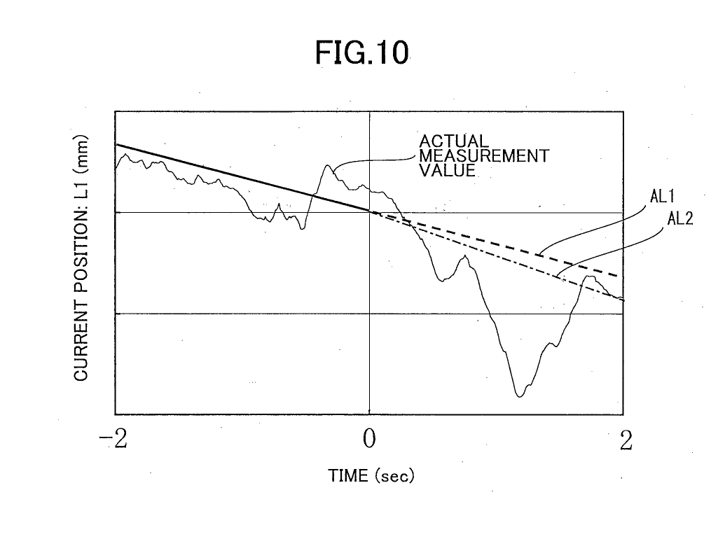

In order to avoid this, as shown in FIG. 10, an average change rate line is calculated by linear approximation (first-order approximation) from relationships between detection distances and times during two seconds before a certain time point (time 0). Then, an imaginary graph (imaginary line) AL1, which is a future change rate line after time 0, is defined from the calculated average change rate line. A value l1 of the imaginary line (AL1) is used as a measurement value (current position l1) measured by the distance sensor 14.

After this graph is prepared, comparison is made between an actual measurement value which is raw data actually outputted from the distance sensor 14 and a value of the imaginary line (AL1). If the actual measurement value differs from the value of the imaginary line (AL1) by more than 10% (percent), the actual measurement value is discarded and is not used for calculation. If the actual measurement value is in a range within 10% of the value of the imaginary line (AL1), the actual measurement value is stored and is used for calculation of an imaginary line that is calculated again. Here, the 10% from the value of the imaginary line (AL1) indicates a line (AL2) that intersects the average change rate line (imaginary line (AL1)) at time 0 and that has a change rate greater than the change rate (slope) of the average change rate line by 10%. Thus, in the graph of FIG. 10, if the actual measurement value of the distance sensor 14 is located below the line (AL2), the actual measurement value is discarded. If the actual measurement value of the distance sensor 14 is located above the line (AL2), the actual measurement value is stored. An imaginary line is calculated by linear approximation (first-order approximation) based on the point-of-original position and on at least actual measurement value that has been measured at the very beginning during two seconds after the start of drilling.

Specifically, as shown in FIG. 11, first in S301, the microcomputer 110 determines whether the depth-control-function ON/OFF button 116 has been pressed. If it is determined in S301 that the depth-control-function ON/OFF button 116 has not been pressed (S301: NO), in S302 the drill operation is performed according to manual drilling depth adjustments based on an operation of the trigger 13, without using the depth control function. If it is determined in S301 that the depth-control-function ON/OFF button 116 has been pressed (S301: YES), in S303 the operator sets an initial position (L0), and then in S304 the operator sets a setting value (Ld) of the drilling depth with the UP button 117A and the DOWN button 117B. In S305, the microcomputer 110 confirms whether the initial position (L0) and the setting value (Ld) are set, and if confirmed (S305: YES), the microcomputer 110 proceeds to S306.

In S306, the trigger 13 is pulled to start drilling. The microcomputer 110 proceeds to S307 to start detection and storing of the current position (L1). The microcomputer 110 then proceeds to S308, calculates an imaginary line from the current position (L1) at each stored time from the starting time of drilling (the timing of S306) to the current time, and sets the value (l1) of the imaginary line as the current position (l1) based on the current time. The microcomputer 110 then proceeds to S309 and determines whether the current position (L1) which is an actual measurement value is in a range of 10% or more of the imaginary line obtained in S308. If it is determined in S309 that the current position (L1) in the distance sensor 14 is in a range of 10% or more of the imaginary line (S309: YES), the microcomputer 110 proceeds to S310 to exclude data of the current position (L1) which is the actual measurement value from data to be used in calculation, and loops back to S308. If it is determined in S309 that the current position (L1) is in a range of less than 10% of the imaginary line (S309: NO), the microcomputer 110 proceeds to S311.

In S311, the microcomputer 110 determines whether a period of two seconds has elapsed after the trigger 13 is pulled to start drilling. If it is determined that a period of two seconds has not elapsed (S311: NO), the microcomputer 110 loops back to S308. If it is determined that a period of two seconds has elapsed (S311: YES), the microcomputer 110 proceeds to S312, obtains an average change rate line by linear approximation from stored data of the current positions (L1) during two seconds immediately before time 0, defines an imaginary line (AL1) which is a line obtained by extending this average change rate line from time 0 and sets the value (l1) of the imaginary line as the current position (l1). The microcomputer 110 then proceeds to S313 and determines whether that the current position (L1) which is the actual measurement value is in a range of 10% or more of the change rate of the imaginary line (AL1) obtained in S312. If it is determined in S313 that the current position (L1) in the distance sensor 14 is in a range of 10% or more of the imaginary line (AL1) (S313: YES), that is, if the current position (L1) is located below the line (AL2) in the graph of FIG. 10, the microcomputer 110 proceeds to S314 to exclude data of the current position (L1) which is the actual measurement value from data to be used in calculation, and loops back to S312. If it is determined that the current position (L1) is in a range of less than 10% of the imaginary line (S313: NO), the microcomputer 110 proceeds to S315 without excluding data of the current position (L1) which is the actual measurement value. In S315, the microcomputer 110 determines whether the current position (l1) which is the value (l1) of the average change rate line (imaginary line (AL1)) has reached a position satisfying an expression Ld≦L0−l1. If it is determined in S315 that the current position (l1) has reached a position satisfying the expression Ld≦L0−l1 (S315: YES), the microcomputer 110 proceeds to S316 to stop rotation of the motor 21. If it is determined in S315 that the current position (l1) has not reached a position satisfying the expression Ld≦L0−l1 (S315: NO), the microcomputer 110 proceeds to S317 to determine whether to change the setting value (Ld). If it is determined that the setting value (Ld) is to be changed (S317: YES), the microcomputer 110 proceeds to S318 to change the setting value (Ld), and subsequently loops back to S306. If it is determined that the setting value (Ld) is not to be changed (S317: NO), the microcomputer 110 proceeds to S312 to continue the operation.

In this way, an imaginary line is defined, and drilling work is performed by setting the value (l1) determined by the imaginary line as the current position (t1). Thus, even when accuracy of the distance sensor 14 decreases due to dusts and the like, a drilling operation can be continued to drill a hole with predetermined depth. In the above-described flowchart, in S312, an imaginary line for two seconds immediately after time 0 is defined based on two seconds immediately before time 0. However, this period (two seconds) may be changed appropriately from performance of the drilling device 1, working environment, and the like. Further, although a ratio of 10% of the imaginary line is used as a threshold value, this ratio can also be changed appropriately, like the above-mentioned period.

In the flowchart shown in FIG. 11, an abnormal state is not taken in to consideration, for example, that the end bit 2 penetrates the workpiece W and the drilling device 1 comes close to the workpiece W abruptly. Thus, a power cutoff section may be provided to cut off power to the motor 21 when such an abnormal state occurs. Specifically, the rotational speed of the motor 21 is detected by the rotor position detecting circuit 115, and also it is determined in S313 whether the current position (L1) is in a range of 10% or more of the imaginary line. If it is determined as YES in S313 and if the rotational speed of the motor 21 is detected to be abnormal, then power supply to the motor 21 is stopped. Generally, if the end bit 2 penetrates the workpiece W, load of the motor 21 decreases and the rotational speed of the motor 21 increases abruptly. Accordingly, this abrupt increase in the rotational speed is detected as abnormality of the motor 21, and it is determined as YES in S313, thereby stopping a drilling operation even when the end bit 2 penetrates the workpiece W. As the power cutoff section, other than the rotational speed of the motor 21, abnormal rotation of the motor 21 may be detected based on the amount of electric current of the motor 21 or the like.

In the flowchart of FIG. 11, steps S308 through S314 are steps for complementing a decrease in accuracy of measurement by the distance sensor 14 due to generation of dusts and the like. Hence, if the accuracy of the distance sensor 14 does not decrease, these steps need not be performed. Thus, next to the step of S307, a step may be provided for determining whether to execute steps of S308 through S314 (abnormal value exclusion control section). In the above-described flowchart, S312 serves as an average drilling speed calculating section and an imaginary drilling depth predicting section, and S313 and S314 serve as an abnormal value excluding section. Further, S315 serves as an imaginary drilling depth recognizing section.

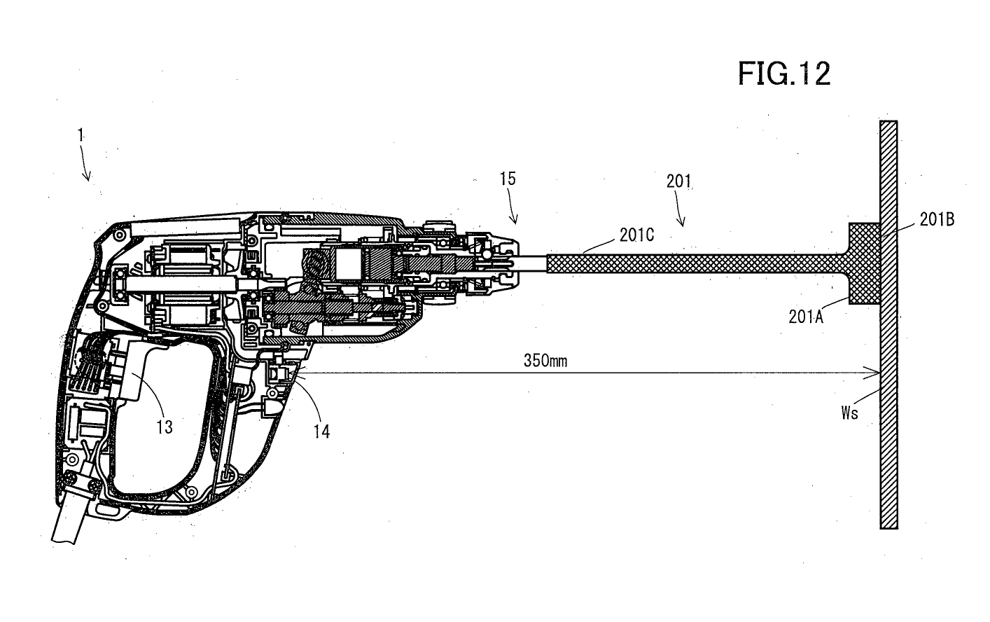

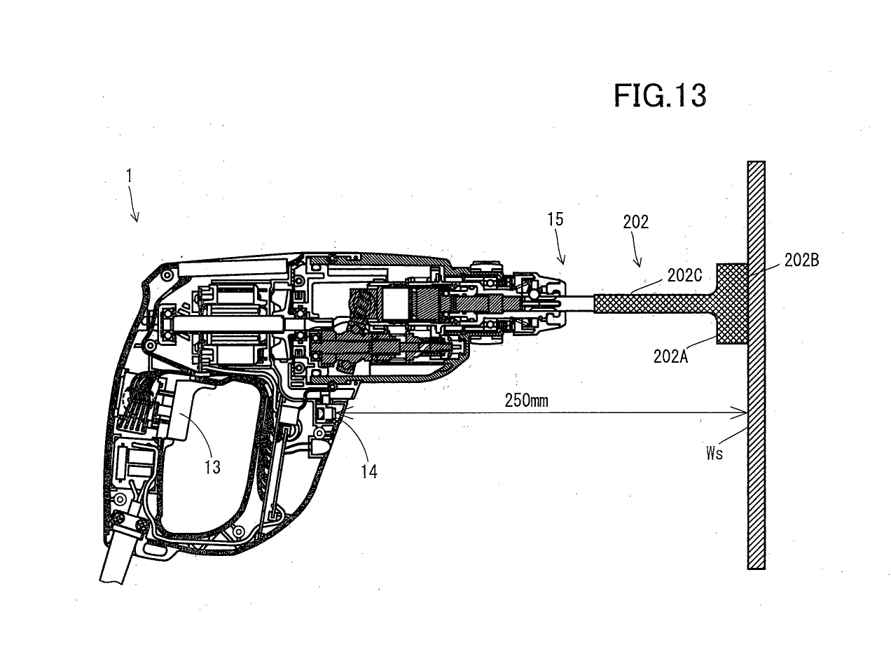

If the characteristics of the distance sensor 14 vary across the ages, there is possibility that accurate values cannot be calculated by the mathematical expression A shown in the graph of FIG. 5. Thus, in this case, a new mathematical expression A is calculated to perform calibration. Specifically, as shown in FIGS. 12 and 13, a first calibration jig 201 and a second calibration jig 202 are mounted to the end bit holding section 15, instead of the end bit 2 (FIG. 1). Distances are measured by the distance sensor 14 in a state where the first calibration jig 201 and the second calibration jig 202 are in contact with a plate material Ws to be measured, and coefficients e and f in the above-described mathematical expression A are newly calculated.

The first calibration jig 201 includes: a flat plate section 201A having a flat surface 201B in a surface contact with the plate material Ws; and a shaft section 201C connected to the flat plate section 201A and extending in a direction perpendicular to the flat surface 201B. The first calibration jig 201 is mounted on the end bit holding section 15 via the shaft section 201C. The length of the shaft section 201C in the axial direction is set so that distance between the flat surface 201B and the distance sensor 14 is 350 mm in a state where the first calibration jig 201 is mounted on the end bit holding section 15.

The second calibration jig 202 includes: a flat plate section 202A having a flat surface 202B and having substantially the same shape as the flat plate section 201A of the first calibration jig 201; and a shaft section 202C connected to the flat plate section 202A and extending in a direction perpendicular to the flat surface 202B. The second calibration jig 202 is mounted on the end bit holding section 15 via the shaft section 202C. The length of the shaft section 202C in the axial direction is set so that distance between the flat surface 202B (the surface of the plate material Ws in contact with the flat surface 202B) and the distance sensor 14 is 250 mm in a state where the second calibration jig 202 is mounted on the end bit holding section 15.

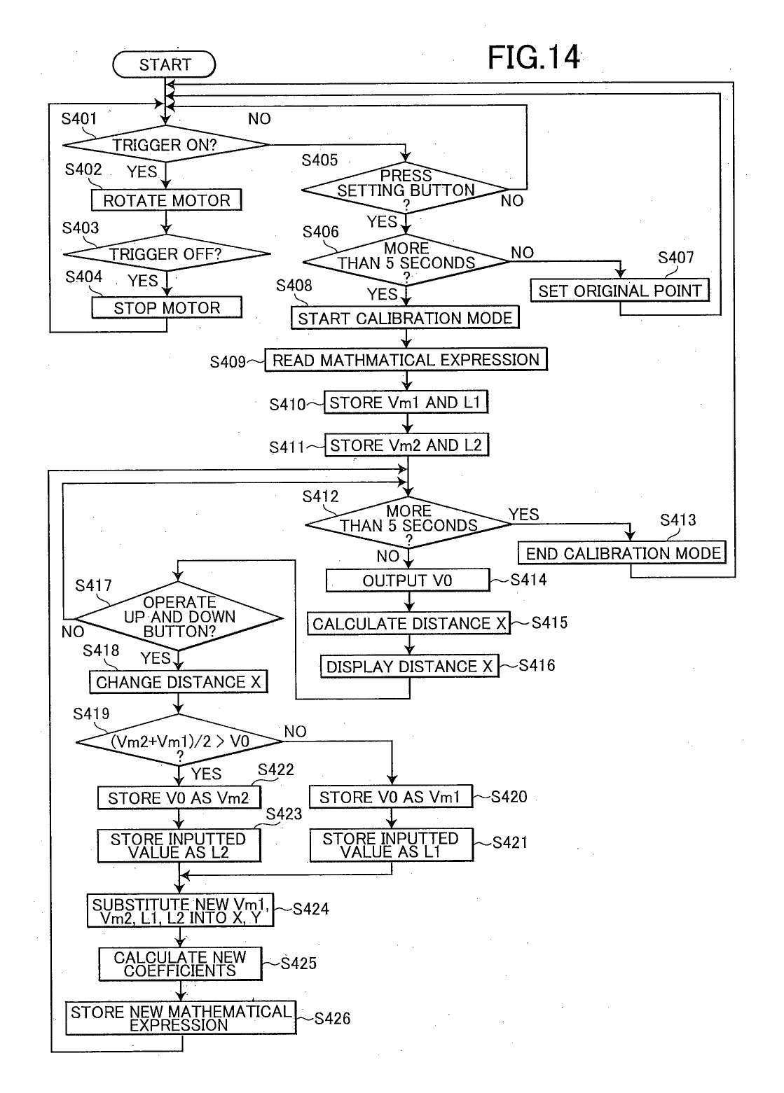

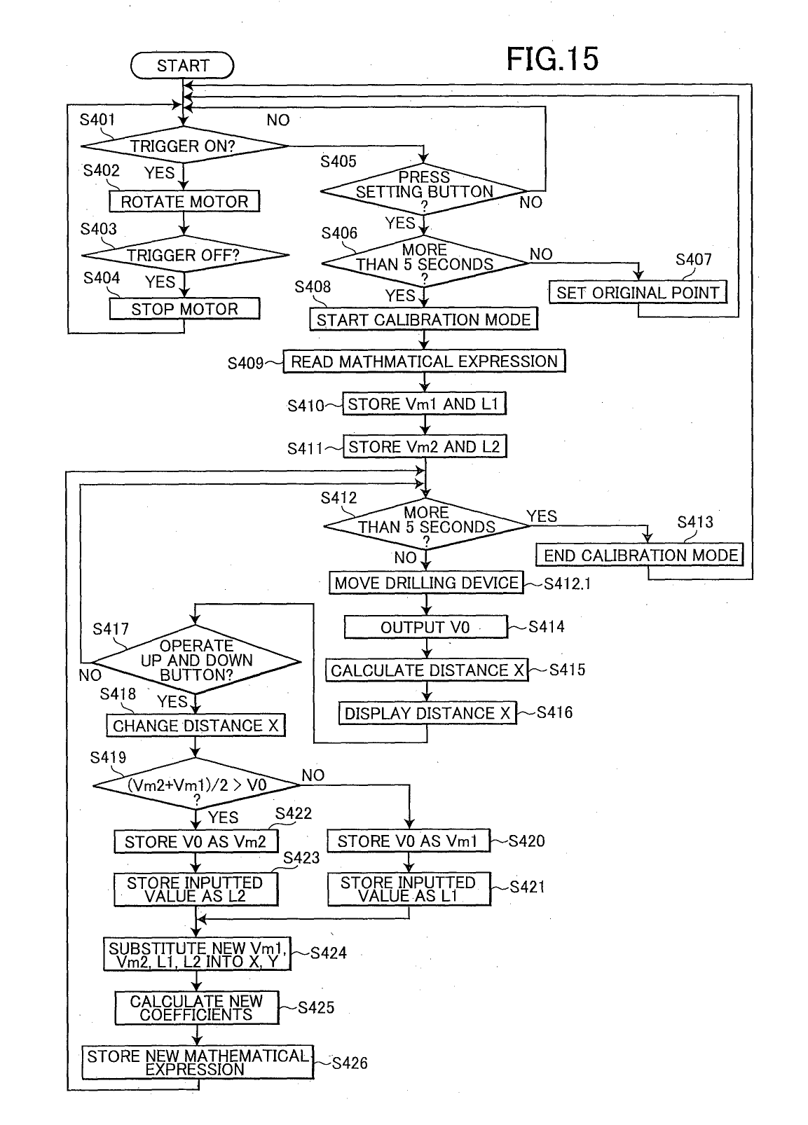

Next, a calibration method for the distance sensor 14 will be described while referring to FIGS. 14 and 15. In order to perform calibration by using the above-described first calibration jig 201 and second calibration jig 202, as shown in the flowchart of FIG. 14, first in S401, the microcomputer 110 determines whether the trigger 13 is pulled. If it is determined in S401 that the trigger 13 is pulled (S401: YES), the microcomputer 110 proceeds to a normal drilling operation shown by S402 through S404.

If it is determined in S401 that the trigger 13 is not pulled (S401: NO), the microcomputer 110 proceeds to S405 to determine whether the point-of-original position setting button 118 has been pressed. If it is determined in S405 that the point-of-original position setting button 118 has not been pressed (S405: NO), the microcomputer 110 loops back to S401. If it is determined in S405 that the point-of-original position setting button 118 has been pressed (S405: YES), the microcomputer 110 proceeds to S406 to determine a period during which the point-of-original position setting button 118 has been pressed. In S406, if the period during which the point-of-original position setting button 118 has been pressed is shorter than five seconds (S406: NO), the microcomputer 110 proceeds to S407 to set the point-of-original position (X=L0), and loops back to S401. In S406, if the period during which the point-of-original position setting button 118 has been pressed is longer than or equal to five seconds (S406: YES), the microcomputer 110 proceeds to S408 to start a calibration mode.

The microcomputer 110 proceeds from S408 to S409 and reads out, from the storage device 120, the mathematical expression A which is the mathematical expression for converting distances shown in FIG. 5. In S410, the operator presses a measurement button to measure output voltage data Vm1 of the distance sensor 14 in a state where the first calibration jig 201 is mounted and the flat surface 201B is pressed against the plate material Ws. Then, the microcomputer 110 calculates distance data L1 corresponding to distance detected by the distance sensor 14 based on the mathematical expression A and the output voltage data Vm1, and stores both of the distance data L1 and the output voltage data Vm1. The distance data L1 is a value substituted into X of the mathematical expression A and the output voltage data Vm1 is a value substituted into Y of the mathematical expression A. After the operator replaces the first calibration jig 201 with the second calibration jig 202, in S411 the microcomputer 110 stores both of: distance data L2 corresponding to distance detected by the distance sensor 14; and output voltage data Vm2 of the distance sensor 14 corresponding to the distance data L2 in the same manner as the output voltage data Vm1 and the distance data L1 for the first calibration jig 201 is stored. The distance data L2 is a value substituted into X of the mathematical expression A and the output voltage data Vm2 is a value substituted into Y of the mathematical expression A. Subsequently, the microcomputer 110 proceeds to S412 (S412 at the first time).

In S412, if it is determined that the period during which the point-of-original position setting button 118 has been pressed is longer than or equal to five seconds (S412: YES), the microcomputer 110 proceeds to S413 to end the calibration mode, and subsequently loops back to S401. In S412, if the period during which the point-of-original position setting button 118 has been pressed is shorter than five seconds (S412: NO), the microcomputer 110 proceeds to S414 to detect an output V0 (V01) outputted from the distance sensor 14.

In S414, the first calibration jig 201 is mounted to the end bit holding section 15 beforehand (jig mounting step), and also measurement by the distance sensor 14 is performed by being pressed the measurement button in a state where the flat surface 201B is pressed against the plate material Ws (distance measuring step). In this state, the distance between the distance sensor 14 and the plate material Ws is 350 mm.

Next, the microcomputer 110 proceeds to S415 and substitutes the output V0 into Y of the mathematical expression A to calculate X, and proceeds to S416 to display this calculated value (X) on the display section 23A. The microcomputer 110 then proceeds to S417 and the UP button 117A and the DOWN button 117B are operated to input the current number (350 mm) (inputting step). If it is determined in S417 that an operator need not operate (S417: NO), that is, if the value on the display section 23A in S416 is identical or substantially identical to the current number (350 mm), then the microcomputer 110 loops back to S412. Descriptions for the case where the microcomputer 110 loops back from S417 to S412 will be provided later together with descriptions for S426.

If it is determined in S417 that an operator need operate (S417: YES), the microcomputer 110 proceeds to S418 and the UP button 117A and the DOWN button 117B are operated to change the display on the display section 23A to the current number (350 mm). Next, the microcomputer 110 proceeds to S419 and determines whether the value V0 detected in S414 is larger than the average value of output voltage data Vm1 and Vm2, that is, to which of the output voltage data Vm1 and Vm2 stored in S410 and S411 the value V0 is closer. Here, the value V0 detected in S414 is the measurement result in a state where the first calibration jig 201 is mounted, and is closer to Vm1 (S419: NO). Thus, the microcomputer 110 proceeds to S420 to store VO1 as a new Vm1, and proceeds to S421 to store inputted value displayed on the display section 23A (350 mm) as a new L1.

Next, the microcomputer 110 proceeds to S424 and substitutes each of new (L1, Vm1) stored in S420, S421 and new (L2, Vm2) stored in S411 into (X, Y) of the mathematical expression A, and proceeds to S425 to calculate new coefficients e and f. The microcomputer 110 then proceeds to S426 to store a new mathematical expression A using the new coefficients e and f, and loops back to S412 (S412 at the second time).

If it is determined that calibration work is not necessary when the microcomputer 110 loops from S426 and S417 to S412 at the second time, the point-of-original position setting button 118 is pressed and held for more than five seconds in S412 at the second time (S412: YES), and proceeds to S413 as described above to end the calibration mode.

When calibration is further needed with the second calibration jig 202, the first calibration jig 201 is detached from the end bit holding section 15 and the second calibration jig 202 is mounted, and the microcomputer 110 proceeds to S414 without pressing the point-of-original position setting button 118 (S412: NO). Descriptions for S414 through S418 are omitted since they are the same as the case of the first calibration jig 201. Next, the microcomputer 110 proceeds to S419 and determines whether the value V0 detected in S414 for the second calibration jig 202 is larger than the average value of output voltage data Vm1 and Vm2, that is, to which of the output voltage data Vm1 and Vm2 stored in S420 and S411 the value V0 is closer. Here, the value V0 detected in S414 is the measurement result in a state where the second calibration jig 202 is mounted, and is closer to Vm2 (S419: YES). Thus, the microcomputer 110 proceeds to S422 to store V01 as a new Vm2, and proceeds to S423 to store inputted value displayed on the display section 23A (250 mm) as a new L2.

Next, the microcomputer 110 proceeds to S424 and substitutes each of new (L1, Vm1) stored in S420, S421 and new (L2, Vm2) stored in S422, S423 into (X, Y) of the mathematical expression A, and proceeds to S425 to calculate new coefficients e and f. The microcomputer 110 then proceeds to S426 to store a new mathematical expression A using the new coefficients e and f, and loops back to S412 (S412 at the third time).

In S412 at the third time, calibration by the first calibration jig 201 and calibration by the second calibration jig 202 have been gone through. Hence, the point-of-original position setting button 118 is pressed and held for more than five seconds (S412:YES) to end the calibration mode.

By calibrating the coefficients e and f of the mathematical expression A in this way, accurate values can be derived even when sensitivity of the distance sensor 14 changes. And, even with the sensor type drilling device 1 having no conventional gauge, accurate drilling depth can be maintained.

In the present embodiment, the first calibration jig 201 and the second calibration jig 202 are used as dedicated jigs. Alternatively, an end bit with a predetermined length which is preliminary known may be used as a jig. Further, if an end bit is used as a jig, it is preferable to have a table listing distances between the distance sensor 14 and the plate material Ws corresponding to a case where each end bit is mounted on the end bit holding section 15 (calibration value deriving section, calibration value deriving step). By using this table, a value inputted in S417 in the above-described flowchart can be identified easily when the end bit with the predetermined length is used as the jig, and calibration work can be made easier. This table may be provided separately from the drilling device 1, or may be provided integrally with the drilling device 1, for example, it may be printed on the handle section 10 or the motor housing 20.

In the above-described flowchart, the sensor output V0 is outputted in S413 immediately after S412. Alternatively, as shown in the flowchart of FIG. 15, step S412.1 may be added after S412, for confirming that the drilling device 1 is moved in a state where either one of the calibration jigs is mounted, and that the measurement distance between the distance sensor 14 and the plate material Ws is changed. By adding this step, a process for calibration by an operator can be clarified.

Although the drilling device 1 is applied to a rotary hammer drill in the present embodiment, it is not limited to a rotary hammer drill. The invention can be applied to any tool that drills a hole into a workpiece, such as driver.

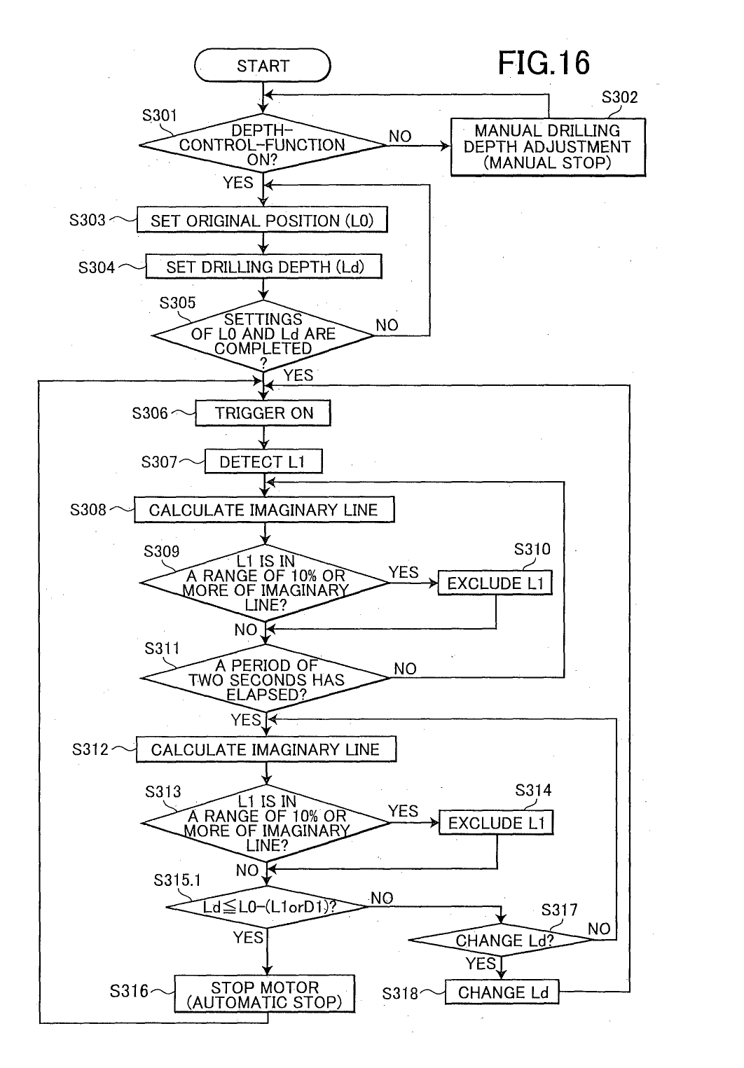

Further, an imaginary line may be defined and drilling work is performed according to a flowchart shown in FIG. 16, in place of the flowchart shown in FIG. 11. Specifically, the microprocessor 110 excludes the data of the current position (L1) which is the actual measurement value from data to be used in calculation in S310 and proceeds to S311 to determine whether a period of two seconds has elapsed after the trigger 13 is pulled to start drilling. Further, in S314 the microprocessor 110 excludes data of the current position (L1) which is the actual measurement value from data to be used in calculation and proceeds to S315.1. If it is determined that the current position (L1) is in a range of less than 10% of the imaginary line (S313: NO), in S315.1 the microcomputer 110 determines whether the drilling depth reaches the setting value Ld based on the current position (l1) (that is, whether Ld−L0−l1 is satisfied). On the other hand, if it is determined that the current position (L1) in the distance sensor 14 is in a range of 10% or more of the imaginary line (AL1) (S313: YES), in S315.1 the microcomputer 110 determines whether the drilling depth reaches the setting value Ld based on the current position (L1) (that is, whether Ld≦L0−L1 is satisfied).

### INDUSTRIAL APPLICABILITY

The invention is especially useful in the field of a drilling device that drills a hole to a desired depth with an end bit against a workpiece.

1. A power tool comprising:
a motor driving an end bit;
a housing accommodating the motor;
a distance measuring sensor provided at the housing; and
a controlling section connected to the distance measuring sensor,
characterized in that
the controlling section is configured to exclude an abnormal value from measurement value measured by the distance measuring sensor.

2. A drilling device comprising:
a mounting section to which a drill bit is mounted;
a housing holding the mounting section;
a distance measuring sensor provided at the housing; and
a controlling section connected to the distance measuring sensor,
characterized in that:
the controlling section comprises:
an abnormal value excluding section that compares the measurement result with an imaginary drilling depth, and that excludes the measurement result when the measurement result shows an abnormal value being out of a predetermined range defined by a threshold value determined from the imaginary drilling depth.

3. The drilling device according to claim 2, wherein the controlling section further comprises:
an average drilling speed calculating section that calculates an average drilling speed, subsequent to a first time in which a first period has elapsed after a start of drilling, based on the measurement result during the first period before the first time; and
an imaginary drilling depth predicting section that predicts the imaginary drilling depth during a second period after the first time, based on the average drilling speed.

4. The drilling device according to claim 2, wherein the controlling section further comprises:
a storage section that stores the measurement result of the distance measuring sensor.

5. The drilling device according to claim 3, wherein the average drilling speed calculating section is configured to change the first period, and the imaginary drilling depth predicting section is configured to change the second period.

6. The drilling device according to claim 2, wherein the abnormal value excluding section is configured to change the predetermined range defined by the threshold value.

7. The drilling device according to claim 2, further comprising:
a motor driving the drilling bit; and
a transmitting mechanism that is provided between the drilling bit and the motor and transmits output of the motor to the drilling bit,
wherein the transmitting mechanism transmits the output of the motor to the drilling bit as a rotational force or as a rotational force and a striking force.

8. The drilling device according to claim 2, further comprising an abnormal-value exclusion control section that controls an operation and a non-operation of the abnormal value excluding section.

9. The drilling device according to claim 2, further comprising a motor that rotates by electric power and that drives the drilling bit,
wherein the controlling section further comprises:
an electric current detecting section that detects an electric current supplied to the motor;
a rotational speed detecting section that detects a rotational speed of the motor; and
a power cutoff section that cuts off power supply to the motor when at least one of two condition is satisfied and when the abnormal value excluding section detects the abnormal value of the measurement result, one condition being such that the electric current detecting section detects an abnormal value of the electric current, the other condition being such that the rotational speed detecting section detects an abnormal value of the rotational speed.
